(19) United States
(12) Patent Application Publication
(10) Pub. No.: US 2009/0170694 A1
(43) Pub. Date: Jul. 2, 2009

(54) CATALYST MATERIAL FOR TREATING PRODUCTS PRODUCED DURING COMBUSTION AND METHOD FOR ITS PREPARATION

(76) Inventors: Joerg Jockel, Ceske Budejovice (CZ); Nelson Ewane Olong, Saarbruecken (DE); Kristina Pokorna, Ludwigsburg (DE)

Correspondence Address: KENYON & KENYON LLP, ONE BROADWAY, NEW YORK, NY, 10004, US

(21) Appl. No.: 12/280,936

(22) PCT Filed: Jan. 3, 2007
(86) PCT No.: PCT/EP2007/050049

§ 371 Date: Jan. 5, 2009

(30) Foreign Application Priority Data
Feb. 27, 2006 (DE) 10 2006 009 015.2

(51) Int. Cl. B01J 23/10; B01J 21/02; B01J 27/057; B01J 21/06

(52) U.S. Cl. 502/202; 502/304; 502/303; 502/215; 502/263

(57) ABSTRACT

A catalyst material is provided for treating products created during combustion which is developed for the catalytic conversion of carbon-containing particles, the catalyst material being applied onto a carrier and the catalyst material including cerium as one catalyst component. In order to provide a catalyst material, using which the catalytic conversion of carbon-containing particles is able to be improved, the catalyst components have at least one additional catalyst component besides cerium, the proportion of cerium amounting to at least 92 mol-% with respect to the entire quantity of the catalyst components. A method is also provided for preparing a catalyst material.

### BACKGROUND INFORMATION

Catalytic devices are used for the treatment of combustion products and combustion exhaust gases which are created, for example, in industrial processes and in engine combustion of fossil fuels, for example. By the use of catalytic devices, both particulate and gaseous and liquid components and pollutants of the combustion products are to be eliminated. Diesel particulate filters are used, for example, in the exhaust gas treatment of exhaust gases that are created in response to the combustion of Diesel fuel. Soot particles, in particular, are filtered out of the exhaust gas flow and oxidized, using a Diesel particulate filter. In addition, exhaust gas components, such as uncombusted hydrocarbons (HC) and carbon monoxide (CO) are to be reacted with oxygen. In the ideal case, the exhaust gas content substances are oxidized to form carbon dioxide and water.

Specific requirements are set for the exhaust gas particulate filter, particularly for a complete degradation of soot particles. Catalytically active substances are used for this in the exhaust gas particulate filter, for eliminating the exhaust gas content substances. Catalytically acting metals, such as platinum, palladium and, if necessary, vanadium or iron are used, for example.

### OBJECT OF THE INVENTION

It is the object of the present invention to provide a catalyst material for the treatment of products created during combustion, using which, the catalytic conversion of carbon-containing particles is able to be improved.

This object is attained by Claim 1 and Claim 10.

Advantageous variants of the present invention are set forth in the dependent claims.

### DISCLOSURE OF THE INVENTION

The present invention starts from a catalyst material for treating products created during combustion, which is developed for the catalytic conversion of carbon-containing particles, the catalyst material being applied onto a carrier and the catalyst material including cerium as a catalyst component. An essential aspect of the present invention is that, besides the cerium, the catalyst components have at least one additional catalyst component, with reference to the overall quantity of the catalyst components, the proportion of cerium amounting to at least 92 mol-%, Because of this measure, the catalytic conversion of carbon-containing particles of the combustion products is able to be implemented particularly effectively. It has been shown that soot catalysis is clearly improved, particularly by comparatively high proportions of cerium in the catalyst components. This particularly makes it possible that the temperature, at which carbon-containing particles are degraded or oxidized and perhaps fully combusted in significant quantities, especially the so-called soot burnoff temperature, is significantly reduced in comparison to other catalyst material compositions. With that, an effective soot particle oxidation is made possible, using the proposed catalyst material, particularly at lower temperatures of the catalyst material, which may occur regularly, in comparison to continuous operation. The cold-start performance of exhaust gas particulate filters is especially improved thereby, for instance, in vehicles having Diesel engines. Because of this, one may particularly provide an effective measure to satisfy legal environmental specifications, such as for reducing contamination by fine dust by passenger car exhaust gases.

The statement of proportions of catalyst components in mol-% refers to the catalytically active substances, and not to filler materials or supporting materials, which may possibly be present in the catalytic layer, and which demonstrate no catalytic action or practically none. Within the meaning of the present invention, besides cerium, one should understand catalyst components basically to mean especially components which are catalytically effective in the degradation of combustion products, particularly metals or semiconductors such as platinum, palladium, rhodium or one of the elements having the chemical symbols shown below.

The catalyst components usually applied to ceramic carriers, such as aluminum oxide particles, may be present, for instance, in an alloy or in compounds having different structures, such as mixtures of elements in molecular form or as complex compounds.

Besides, for instance, the reduction in the soot burnoff temperature, using the provided catalyst material achieves, in addition, that the temperature peaks created during the soot burnoff are comparatively lower, or able to be modulated. The carrier material, onto which the catalyst components are applied, are thereby able to be protected from heat-conditioned damage caused by soot burnoff.

With reference to the entire quantity of catalyst components, the proportion of cerium is advantageously between 92 mol-% and 99.5 mol-%. In order to make possible a catalytically effective degrading action, for instance, even for non-particulate combustion products, such as HC or CO, in particular, at least one additional catalyst component is provided beside the main component, cerium. Especially metals or semiconductors may be used for this, for example, platinum, palladium, rhodium and compounds or mixtures with these substances.

In one preferred specific embodiment of the subject matter of the present invention, besides cerium, the catalyst components include exactly one additional catalyst component, and the proportion of cerium with respect to the entire quantity of catalyst components is between 95 mol-% and 99.5 mol-%. It has been shown that, using the comparatively high proportion of cerium named and exactly one additional catalyst component, the degrading performance of particulate combustion products is able to take place especially advantageously. Especially using cerium proportions in the range cited and one additional catalyst substance, a significant reduction in the burnoff temperature of carbon-containing particles, such as soot, and the effective oxidation of HC and CO are possible.

The exactly one additional catalyst component is advantageously formed by one of the chemical elements having the chemical symbol K, B, Cd, Cr, Dy, Er, Gd, Ho, Ca, La, Li, Lu, Mg, Mn, Nd, Pr, Sm, Se, Y, Zn, Sn, Eu, Sb, Cs, Ru, Ga, Ge, Hf, In, Cu, Na, Ag, Si, Tb, Yb, Zr, Bi, Mo, Nb, Rb, Sc, W, Sr, Ti, Te, Ba, Tm, Ta, Co and Ni. Because of the combination of one of the chemical elements named with cerium, the composition of the catalyst materials may be set up in a multitude of ways. Because of the different combinations possible with cerium, the catalyst material may be optimally adapted to respectively different application uses, especially in order to implement a great catalytic effect for the respective combustion product that is to be treated.

In one particularly preferred embodiment of the subject matter of the present invention, the proportions of the catalyst components are determined according to one of the following element formulas Ag₃Ce₉₇, Mn₃Ce₉₇ and K₃Ce₉₇, the subscript numbers in the formulas stating the mol-percentage of the previously mentioned catalyst component with respect to the overall quantity of the two catalyst components. Based on the combinations of the catalyst components silver, manganese and potassium mentioned, in each case with cerium, a comparatively clear reduction in the burnoff temperature of carbon-containing particles of the soot burnoff temperature was able to be determined. Comparative experiments were carried out, for instance, based on differential thermal analysis (DTA), in which the respective catalyst materials were mixed with soot and heated in synthetic air from room temperature to 800° C. In this context, the reduction in the soot as a relative mass of the soot to the initial mass, and the temperature prevailing in this context in the experimental room were recorded, and their relationship was established and shown as a curve. In order to make a comparative valuation of the catalytic activity of the respective composition of the catalyst components, those temperatures were particularly ascertained at which a loss in the mass of soot occurred that was less than 50%. For the reference curve, the combustion of pure soot was measured without catalytic support.

In one advantageous specific embodiment of the catalyst material, besides cerium, the catalyst components include exactly two additional catalyst component, and the proportion of cerium with respect to the entire quantity of catalyst components is between 92 mol-% and 99.4 mol-%. Within the given proportion of cerium in the case of three catalyst components, a particularly effective reduction in the burnoff temperature of carbon-containing particles has come about at simultaneously high oxidation action of the catalyst material on gaseous combustion products.

In the specific embodiment of the present invention just named, it is particularly advantageous if a catalyst component is formed by platinum, having a proportion with respect to the entire quantity of the catalyst components between 0.1 mol-% and 3.0 mol-%. This enables reliable implementation of a catalytically supported combustion of gaseous hydrocarbons (HC) and carbon monoxide (CO). Comparatively small proportions of platinum with respect to the overall quantity of catalyst components are sufficient, in this context.

It is especially advantageous if, besides cerium and platinum, a third catalyst component is provided having a proportion with respect to the overall quantity of catalyst components between 0.5 mol-% and 5.0 mol-%. Using the three catalyst components mentioned, the degradation performance of the catalyst material and the effectiveness with regard to the particulate and gaseous combustion products may be managed effectively.

It is particularly preferred if the third catalyst component is formed by one of the chemical elements having the chemical symbol K, B, Cd, Cr, Dy, Er, Gd, Ho, Ca, La, Li, Lu, Mg, Mn, Nd, Pr, Sm, Se, Y, Zn, Sn, Eu, Sb, Cs, Ru, Ga, Ge, Hf, In, Cu, Na, Ag, Si, Tb, Yb, Zr, Bi, Mo, Nb, Rb, Sc, W, Sr, Ti, Te, Ba, Tm, Ta, Co and Ni.

In one particularly preferred embodiment of the subject matter of the present invention, having cerium and exactly two additional catalyst components, the proportions of the catalyst components are determined according to one of the following element formulas Pt_{0.5}La₃Ce_{96.5}, Pt_{0.5}Al₃Ce_{96.5} and Pt_{0.5}K₃Ce_{96.5} the subscript numbers in the formulas stating the mol-percentage of the previously mentioned catalyst component with respect to the overall quantity of the three catalyst components. Using the above-mentioned proportions of cerium, platinum and one additional component, a clear reduction in the burnoff temperature of soot particles may be achieved, which we were able to confirm experimentally, for instance, by burnoff experiments using the proportions of the catalyst components named.

According to one further essential aspect of the present invention, a method is provided for the preparation of a catalyst material on a carrier, particularly for one of the catalyst materials mentioned above, which is distinguished by the fact that a sol-gel process is used for the formation of the catalyst components on the carrier. Using such a sol-gel process (S-G-P), metals may be inserted, for instance, as complexes distributed homogeneously in oxide materials. Doping by the catalytically active component may take place in any quantity desired. Using thermolytic decomposition of the metal complexes, for example, or by treatment in an oxygen plasma, highly dispersed metal oxide particles or metal particles may be produced which, among other things, may be used as heterogenous catalyst materials. They are distinguished by very small, homogeneously distributed and non-agglomerated particles, a tight particle size distribution and a very variable degree of loading. Soluble metalorganic compounds, such as alkoxides, alcoholates and propionates may particularly be used which, for example, form a gel by undergoing a condensation step and splitting off water. One advantage of the sol-gel process is that it permits producing good ceramic or metal oxide coatings, using which one is able to coat ceramic fibers, particles and ceramic carriers. If an alcoholic solution of the hydrolyzable alcoholate of multivalent metal ions, such as of titanium, cobalt, manganese, molybdenum, silicon, aluminum, etc., is applied to a surface, a metal hydroxide network forms in the presence of moisture, even during the evaporation of the solvent at these temperatures. It contains numerous metal hydroxide (MOH) groups and is therefore hydrophilic and antistatic. At an increased temperature, the MOH groups then react to form metal oxide groupings while water is split off, and the surfaces become mechanically very stable.

In an alternative method, a preparation can take place starting from metal salt solutions of nitrates, acetates, citrates or carbonates. The solutions are dried and subsequently calcined at temperatures of ca. 400 to ca. 800° C., the corresponding anions are thermally decomposed in the process, and the corresponding metal oxides are formed.

### DESCRIPTION OF THE FIGURES

The present invention is explained in greater detail with reference to the only figures shown in the drawing,

FIG. 1 shows curve shapes obtained by combustion experiments, of which one shows the combustion of soot without catalyst material, and the others show the combustion of soot mixed in each case with another catalyst material of a different composition. The experiments were carried out using differential thermal analysis.

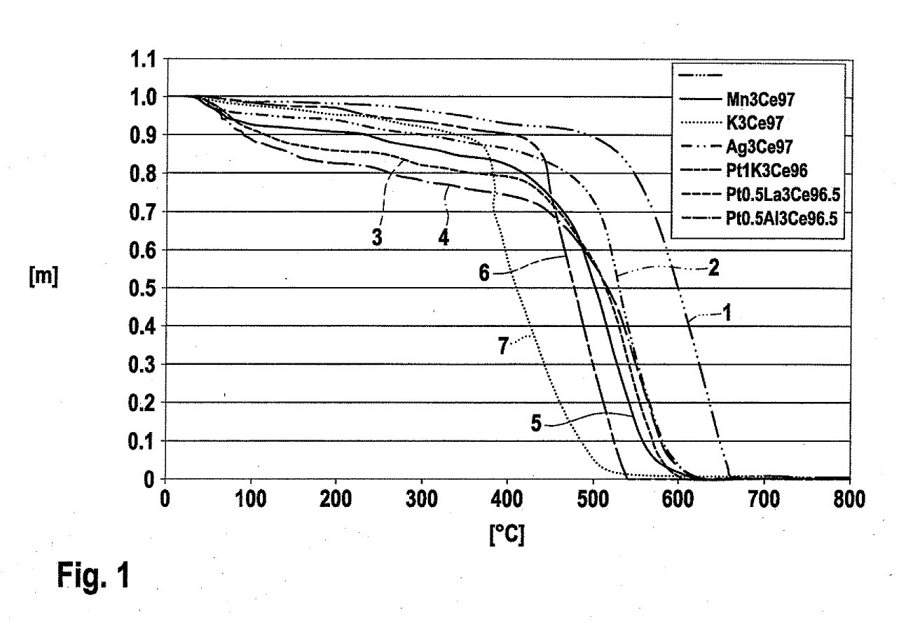

The different curve shapes shown in FIG. 1 are shown in an orthogonal coordinate system, the temperature T in degrees centigrade up to 800° C. measured in the test room being shown on the abscissa, and the relative weight m of the investigated soot quantity, with respect to the initial soot quantity present at the beginning of the experiment, being shown on the ordinate. For the catalytically supported combustion experiments, the respective specific embodiment of the catalyst materials was mixed with soot in a ratio of soot to catalyst material of 1 to 4, and heated in synthetic air having 20% oxygen and 80% nitrogen from room temperature up to ca. 800° C. The rate of heating was 10 Kelvin per minute. The volume flow of the synthetic air was set to 50 milliliter per minute.

For the assessment of the catalytic effect of the different catalyst components, besides the overall curve shape up to the complete combustion of the soot, in particular, those temperatures were ascertained at which a loss in mass of the soot versus the initial soot quantity of 50% was determined. In the diagram as in FIG. 1, these reference temperatures T50 in ° C. may be ascertained by the intersection of the individual measuring curves with the ordinate value of m=0.5. Curve 1 in FIG. 1 relates to the combustion experiment of pure soot, and the additional curves relate to soot combustion using catalyst material Ag₃Ce₉₇ (curve 2), Pt_{0.5}La₃Ce_{96.5} (curve 3), Pt_{0.5}Al₃Ce_{69.5} (curve 4), Mn₃Ce₉₇ (curve 5), Pt₁K₃Ce₉₆ (curve 6) and K₃Ce₉₇ (curve 7).

Table 1, shown below, shows the temperatures T50 in ° C. measured in the process, for pure soot and the individual investigated mixtures of soot with the different catalyst materials named. The respective compound type of the catalyst components is also given in the table. The highest reference temperature T50 measured in the experiments of 600° C. was measured for pure soot. The clearest reduction in reference temperature T50 of 411° C. was measured for catalyst material K₃Ce₉₇.

TABLE 1

| Compound type | Compound measured | T50 [° C.] |
|---|---|---|
| | soot | 600 |
| Ag_{0.5-5.0} Ce_{95.0-99.5} | Ag₃Ce₉₇ | 530 |
| Pt_{0.1-3.0}La_{0.5-5.0} Ce_{92.0-99.4} | Pt_{0.5}La₃Ce_{96.5} | 518 |
| Pt_{0.1-3.0} Al_{0.5-5.0}Ce_{92.0-99.4} | Pt_{0.5}Al₃Ce_{96.5} | 517 |
| Mn_{0.5-5.0}Ce_{95.0-99.5} | Mn₃Ce₉₇ | 501 |
| Pt_{0.1-3.0} K_{0.5-5.0}Ce_{92.0-99.4} | Pt₁K₃Ce₉₆ | 477 |
| K_{0.5-5.0} Ce_{95.0-99.5} | K₃Ce₉₇ | 411 |

What is claimed is:

1. A catalyst material for treating products created during a combustion, which is developed for a catalytic conversion of carbon-containing particles, the catalyst material being applied onto a carrier and the catalyst material including cerium as one catalyst component, wherein the catalyst components have at least one additional catalyst component besides cerium, the proportion of cerium amounting to at least 92 mol-% with respect to the entire quantity of the catalyst components.

2. The catalyst material as recited in claim 1, wherein with reference to the entire quantity of the catalyst components, the proportion of cerium is between 92 mol-% and 99.5 mol-%.

3. The catalyst material as recited in one of the preceding claims, wherein, besides cerium, the catalyst components include exactly one additional catalyst component, and the proportion of cerium with respect to the entire quantity of catalyst components is between 95 mol-% and 99.5 mol-%.

4. The catalyst material as recited in claim 3, wherein the one additional catalyst component is formed by one of the chemical elements having the chemical symbol K, B, Cd, Cr, Dy, Er, Gd, Ho, Ca, La, Li, Lu, Mg, Mn, Nd, Pr, Sm, Se, Y, Zn, Sn, Eu, Sb, Cs, Ru, Ga, Ge, Hf, In, Cu, Na, Ag, Si, Tb, Yb, Zr, Bi, Mo, Nb, Rb, Sc, W, Sr, Ti, Te, Ba, Tm, Ta, Co and Ni.

5. The catalyst material as recited in one of claims 3 and 4, wherein the proportions of the catalyst components are determined according to one of the following element formulas Ag₃Ce₉₇, Mn₃Ce₉₇ and K₃Ce₉₇, the subscript numbers in the formulas stating the mol-percentage of the previously mentioned catalyst component with respect to the overall quantity of the two catalyst components.

6. The catalyst material as recited in claim 1 or 2, wherein, besides cerium, the catalyst components include exactly two additional catalyst components, and the proportion of cerium with respect to the entire quantity of catalyst components is between 92 mol-% and 99.4 mol-%.

7. The catalyst material as recited in claim 6, wherein one catalyst component is formed by platinum, having a proportion with respect to the overall quantity of the catalyst components between 0.1 mol-% and 3.0 mol-%.

8. The catalyst material as recited in claim 6 or 7, wherein, besides cerium and platinum, a third catalyst component is provided having a proportion with respect to the overall quantity of catalyst components between 0.5 mol-% and 5.0 mol-%.

9. The catalyst material in one of the claims 6 through 8, wherein the third catalyst component is formed by one of the chemical elements having the chemical symbol K, B, Cd, Cr, Dy, Er, Gd, Ho, Ca, La, Li, Lu, Mg, Mn, Nd, Pr, Sm, Se, Y, Zn, Sn, Eu, Sb, Cs, Ru, Ga, Ge, Hf, In, Cu, Na, Ag, Si, Tb, Yb, Zr, Bi, Mo, Nb, Rb, Sc, W, Sr, Ti, Te, Ba, Tm, Ta, Co and Ni.

10. The catalyst material in one of claims 6 through 9, wherein the proportions of the catalyst components are determined according to one of the following element formulas Pt_{0.5}La₃Ce_{96.5}, Pt_{0.5}Al₃Ce_{96.5} and Pt_{0.5}K₃Ce_{96.5}, the subscript numbers in the formulas stating the mol-percentage of the previously mentioned catalyst component with respect to the overall quantity of the three catalyst components.

11. A method of preparing a catalyst material on a carrier, in particular a catalyst material as recited in one of claims 1 through 10, wherein a sol-gel process is used to develop the catalyst components on the carrier.
